(19) United States
(12) Patent Application Publication
(10) Pub. No.: US 2020/0079337 A1
(43) Pub. Date: Mar. 12, 2020

(54) MASTER BRAKE CYLINDER, BRAKING SYSTEM

(71) Applicant: Robert Bosch GmbH, Stuttgart (DE)

(72) Inventors: Chris Anderson, Paris (FR); Dirk Foerch, Neuenstadt/Stein (DE); Matthias Kistner, Bretzfeld (DE); Raynald Sprocq, Esbly (FR); Simon Hansmann, Plymouth, MI (US); Florent Yvonet, Trilport (FR)

(21) Appl. No.: 16/462,888

(22) PCT Filed: Oct. 5, 2017
(86) PCT No.: PCT/EP2017/075335

§ 371 Date: May 21, 2019

(30) Foreign Application Priority Data
Nov. 30, 2016 (DE) 10 2016 223 760.8

(51) Int. Cl. B60T 11/20; B60T 11/16

(52) U.S. Cl. CPC B60T 11/20; B60T 13/165; B60T 11/165

(57) ABSTRACT

A master brake cylinder for a braking system of a motor vehicle, including a hydraulic cylinder which includes multiple hydraulic connections and in which at least one hydraulic piston is mounted axially displaceably in an actuating direction and in a relief direction, the hydraulic piston being displaceable in the actuating direction against the force of a spring element, and a restraint which limits the maximum spring relief being assigned to the spring element. The restraint includes a restraining cylinder and a restraining piston mounted axially displaceably in the restraining cylinder, the restraining cylinder having at least one lateral-wall opening so that an interior of the restraining cylinder is connected to an interior of the hydraulic cylinder.

### FIELD OF THE INVENTION

The present invention relates to a master brake cylinder for a braking system of a motor vehicle, including a hydraulic cylinder which includes multiple hydraulic connections and in which at least one hydraulic piston is mounted axially displaceably in an actuating direction and in a relief direction, the hydraulic piston being displaceable in the actuating direction against the force of a spring element, and a restraint which limits the maximum spring relief is assigned to the spring element. The present invention furthermore relates to a braking system for a motor vehicle including such a master brake cylinder.

### BACKGROUND INFORMATION

Master brake cylinders of the type mentioned at the outset are believed to be in the related art. To convert the actuating force exerted by a driver on a brake pedal into a hydraulic pressure for actuating hydraulic wheel brakes, it is known to mechanically connect the brake pedal to a hydraulic piston which is mounted axially displaceably in the hydraulic cylinder. When the driver actuates the brake pedal, the hydraulic piston is displaced against the force of a spring element, so that the spring element is preloaded or further preloaded. Due to the displacement of the hydraulic piston in the hydraulic cylinder, a volume in the interior of the hydraulic cylinder is decreased, whereby a fluid present therein is pressurized and transported through at least one of the hydraulic connections out of the master cylinder to actuate at least one of the wheel brakes.

When the driver takes his or her foot off the brake pedal, the tensioned spring element, by virtue of its inherent elasticity, pushes the hydraulic piston back into its starting position, hydraulic medium reaching the hydraulic cylinder through one of the hydraulic connections at the same time, so that thereafter the master brake cylinder is ready and available for a further brake application.

If a restraint is assigned to the spring element, this causes the maximum relaxation of the spring element to be mechanically limited during the relief of the hydraulic piston by the driver.

### SUMMARY OF THE INVENTION

The master brake cylinder according to the present invention having the features described herein has the advantage that the restraint includes a restraining cylinder and a restraining piston mounted axially displaceably in the restraining cylinder, the restraining cylinder having at least one lateral-wall opening so that an interior of the restraining cylinder is connected to an interior of the master cylinder. A connection between the interior of the hydraulic cylinder and the interior of the restraining cylinder is created through the lateral-wall opening, through which the fluid present in the hydraulic cylinder also flows into the interior of the restraining cylinder. This also causes the movement of the restraining piston in the restraining cylinder to be determined as a function of the pressure conditions in the interior of the restraining cylinder which result from the inflowing or outflowing fluid. In this way, a damping of the movement of the restraining piston is achieved which, in particular, reduces the maximum movement velocity of the restraining piston to a predefinable value, so that the maximum return stroke velocity of the hydraulic piston during a movement in the relief direction is limited to a permissible value. In this way, a hard strike of the hydraulic piston against the end of the hydraulic cylinder is avoided, and moreover also a pedal oscillation on the brake pedal, which could be perceived by the driver. Moreover a pedal force simulator, which includes or forms at least one hydraulic pressure accumulator counteracting the actuation of the hydraulic piston, may be assigned to the master brake cylinder. In this way, the pushing back of the hydraulic piston into its starting position is also supported, but reduced to a maximum degree due to the advantageously configured restraint. As a result of the damped spring restriction, the acceleration of the brake pedal is decreased when the actuating force is removed, so that the brake pedal is able to move into its resting position without further acceleration, an oscillation of the brake pedal or an acoustically perceptible striking of the brake pedal in its resting position being prevented. The lateral-wall opening may be situated in the restraining cylinder in such a way that the damping does not impede the actuation or displacement of the hydraulic piston in the actuating direction, the damping, in particular, being maximally effective until the hydraulic connection to the piston is reached.

According to one refinement, it is provided that the lateral-wall opening opens into a section in the restraining cylinder into which the restraining piston is moved during a displacement of the hydraulic piston in the actuating direction. In this way, it is achieved that, when the brake pedal is depressed or the hydraulic piston moves in the actuating direction, the restraining piston may be pushed into the restraining cylinder without later counter pressure, while the fluid present in the chamber is able to flow out of the restraining cylinder and into the hydraulic cylinder. During the depression of the brake pedal, an advantageous volume compensation thus takes place, which does not impair the depression of the brake pedal. During the movement of the hydraulic piston in the loading direction by the spring element, the restraining piston reaches a section of the restraining cylinder which is configured without a jacket opening, so that a fluid counteracts the movement of the piston in the remaining chamber, and thereby ensures the damping. As a result of the positioning of the lateral-wall opening or lateral-wall openings, the damping action of the restraint is thus settable in a simple manner.

The restraining piston may be guided at least essentially closely against the restraining cylinder. In this way, the above-described effect is ensured: that the fluid is essentially trapped in the closed chamber between the restraining piston and the restraining cylinder during a movement in the relief direction and counteracts the movement of the restraining piston. A radial leakage gap may be present, which determines the damping power.

Furthermore, it may be provided that the restraining cylinder and the restraining piston each include an end disk at their ends facing away from one another, the spring element being held between the end disks in an axially preloaded manner. The restraint is thus formed at its ends by the end disks, between which the spring element is held in an axially preloaded manner. In this way, the spring element always pushes the restraining piston away from the end disk of the restraining cylinder. Advantageously, the end disk of the restraining piston is situated on a piston rod, which leads through an end wall of the restraining cylinder into the restraining cylinder and is fixedly connected there to the restraining piston. The ratio of the outside diameter of the piston rod to the inside diameter of the opening in the end face of the restraining cylinder furthermore influences the damping of the restraint when the piston is moved in the direction of the end face away from the end disk of the restraining piston. By appropriately selecting the cross sections of the piston rod and the end wall opening for forming a defined leakage gap, it is thus possible to advantageously influence the damping of the restraint.

The spring element may be configured as a helical spring and situated coaxially to the restraining piston and the restraining cylinder. In this way, the restraining piston, the restraining cylinder and the helical spring clamped between the end disks thereof form an advantageous assembly unit, which may be prefabricated and easily situated in the hydraulic cylinder.

Furthermore, it may be provided that at least one of the end disks is fixedly connected to the hydraulic piston. As an alternative, the piston rod is fixedly connected to the hydraulic piston, which then forms the end disk for the restraining piston. As a result of the restraint connection, it is achieved that not only the acceleration of the brake pedal or of the hydraulic piston is damped or limited during the relief, but that the movements of the brake pedal and of the hydraulic piston are actively decelerated. This is advantageous, in particular, with respect to the pedal since, in this way, an excessively fast return of the brake pedal is prevented, and the sensation of a conventional brake pedal is simulated to the user, which exists with conventional braking systems including vacuum brake boosters.

The other of the end disks may be fixedly connected to the hydraulic cylinder, in particular to an end wall of the hydraulic cylinder. In this way, it is ensured that the restraint has a fixed anchor point on the hydraulic cylinder, with the aid of which the braking action is exerted on the hydraulic piston during the relief.

Furthermore, it may be provided that the master brake cylinder is configured as a tandem cylinder, including a further hydraulic piston, which is axially displaceable in the master brake cylinder against the force of a further spring element and is situated between the hydraulic piston and an end face of the hydraulic cylinder. Tandem cylinders are already known from the related art, so that its configuration shall not be addressed in detail at this point. What is important is that a tandem cylinder does not include one hydraulic piston, but two hydraulic pistons, which are arranged in series in the hydraulic cylinder. As a result of the further hydraulic piston, it is achieved that a further brake circuit is operated by the master brake cylinder, independently from a first brake circuit actuated by the hydraulic piston.

A further restraint may be assigned to the further hydraulic piston, which is configured as the above-described restraint. In this way, it is achieved that overall the tandem cylinder dampens and possibly decelerates the pushing movement of the brake pedal, in particular when the further restraint is also fixedly connected to the further hydraulic piston on the one hand, and to the end face of the hydraulic cylinder on the other hand. The former restraint is advantageously fixedly connected to the one hydraulic piston and the further hydraulic piston, and is thus situated axially therebetween.

The braking system according to the present invention having the features described herein is characterized by the configuration of the master brake cylinder according to the present invention. This yields the aforementioned advantages.

Furthermore, the present invention relates to a braking system for a motor vehicle, including a master brake cylinder connected to at least one hydraulic circuit, which includes at least one hydraulically actuatable wheel brake.

Further advantages and features and feature combinations result from what was described above and from the claims.

The present invention is to be described in greater detail hereafter based on the drawings.

### BRIEF DESCRIPTION OF THE DRAWINGS

FIG. 1 shows a braking system of a motor vehicle in a simplified illustration.

FIG. 2 shows a master brake cylinder of the braking system according to a first exemplary embodiment.

FIG. 3 shows the master brake cylinder according to a second exemplary embodiment, each in a simplified longitudinal sectional illustration.

### DETAILED DESCRIPTION

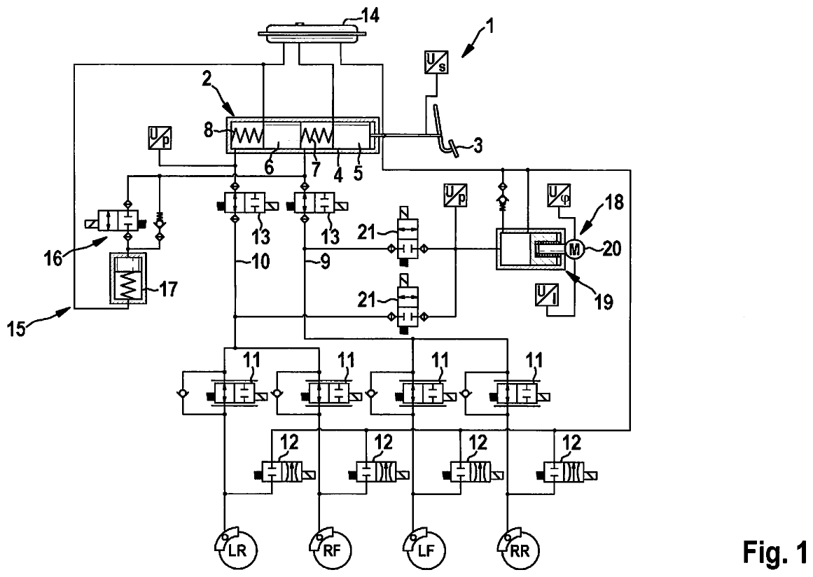

FIG. 1 shows, in a simplified illustration, a braking system 1 for a motor vehicle, which is not shown in greater detail. Braking system 1 includes a master brake cylinder 2, which is configured as a tandem cylinder and actuatable via a brake pedal 3 by a driver of the motor vehicle. The master brake cylinder includes a hydraulic cylinder 4 in which a hydraulic piston 5, which is mechanically fixedly connected to brake pedal 3, and a further hydraulic piston 6 are each mounted in an axially displaceable manner. A spring element 7 is situated in an axially preloaded manner between hydraulic piston 5 and hydraulic piston 6, and a further spring element 8 is situated in an axially preloaded manner between hydraulic piston 6 and an end face of hydraulic cylinder 4, so that chambers which communicate with hydraulic connections of braking system 1 are formed in each case in hydraulic cylinder 4 between hydraulic pistons 5 and 6. In particular, two brake circuits 9 and 10 are connected to master brake cylinder 2 by the hydraulic connections in such a way that one of brake circuits 9 is fluidically connected to one of the hydraulic chambers, and the other of brake circuits 10 is fluidically connected to the other hydraulic chamber. In this way, the two brake circuits 9, 10 may be operated by master brake cylinder 2.

The two brake circuits 9 and 10 are essentially configured identically to one another. Each brake circuit 9, 10 includes two wheel brakes LR, RF and LF, RR, which are actuatable by intake valves 11 and discharge valves 12 in the respective brake circuit 9, 10. Brake circuits 9, 10 are each connectable by high pressure switching valves 13 to one of the chambers of master brake cylinder 2.

In a tank 14, which is also connected to master brake cylinder 2, a fluid or a brake fluid is provided, which is able to enter brake circuits 9, 10 by actuation of master brake cylinder 2. In the present braking system 1, it is provided that a vacuum brake booster is dispensed with. For this reason, brake pedal 3 is also directly mechanically connected to hydraulic piston 5.

However, to convey to the driver the customary pedal sensation, braking system 1 moreover includes a brake pedal sensation simulator 15, which includes a switching valve 16 and a pressure accumulator 17. Brake pedal sensation simulator 15 is used to influence the pedal movement of brake pedal 3 in such a way that it corresponds, or almost corresponds, to that of a brake pedal which is connected to a vacuum brake booster. In this way, the driver is provided with the customary brake pedal sensation.

According to the present exemplary embodiment, a brake boost takes place by an electromechanical brake booster 18, which includes a pump 19, which in the present example is a piston pump, which is drivable by an electric motor 20, to increase a hydraulic pressure in brake circuits 9, 10 as needed. For this purpose, brake circuits 9, 10 are each connected to brake booster 18 by a switching valve 21.

Spring elements 7, 8 of master brake cylinder 2 ensure that hydraulic pistons 5, 6 are returned into a starting position following the actuation by brake pedal 3.

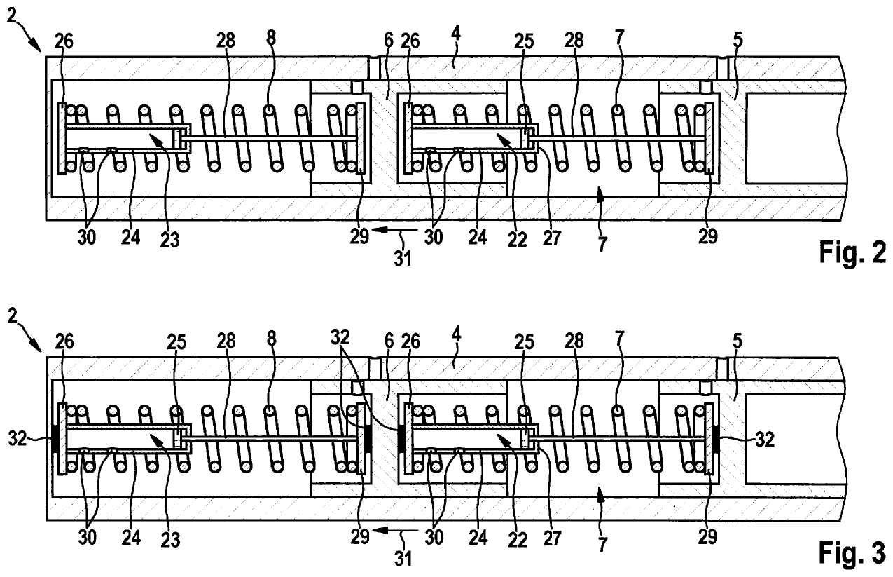

FIG. 2 shows, in this regard, master brake cylinder 2 according to a first exemplary embodiment in a simplified longitudinal sectional illustration. Elements already known from FIG. 1 are denoted by the same reference numerals, so that reference is made to the above description in this regard.

Each of spring elements 7, 8 is assigned a restraint 22 and 23. The two restraints 22, 23 have an identical configuration, so that the configuration and function of the two restraints is described hereafter in greater detail based on restraint 22.

Restraint 22 includes a restraining cylinder 24 in which a restraining piston 25 is mounted axially displaceably.

Restraining cylinder 24 is oriented coaxially to hydraulic cylinder 4 so that the displacement direction of restraining piston 25 also corresponds to the displacement direction of hydraulic pistons 5, 6. On a first end face, restraining cylinder 24 includes an end disk 25, and on its second end face is includes an end wall 27, in which a through-opening is formed. A piston rod 28, which is fixedly connected to restraining piston 25, extends through the through-opening. At its end facing away from restraining piston 25, piston rod 28 carries a further end disk 29. Respective spring element 7 and 8 is held between the two end disks 29 and 26 in an axially preloaded manner. For this purpose, spring element 7, 8 is configured as a helical spring, which extends coaxially to restraining cylinder 24 and piston rod 28. Since restraining piston 25 is configured to be larger than the through-openings of end wall 27, restraining piston 25 may be maximally displaced up to end wall 27. This limits the maximum extension of spring element 7 and 8. Restraining piston 25 rests against restraining cylinder 24 in a radially sealing manner or at least essentially in a sealing manner. A leakage gap may remain. It may also be provided that piston rod 28 and the through-opening are configured in such a way that a leakage gap is created therebetween, so that a fluid is able to enter from the chamber between restraining piston 25 and end wall 27 in restraining cylinder 24 through the leakage gap either directly into the interior of hydraulic cylinder 4, or into the hydraulic chamber between restraining piston 25 and end disk 26.

Multiple lateral-wall openings 30 are formed in restraining cylinder 24, which are situated close to end disk 26. Via lateral-wall openings 30, the chamber in restraining cylinder 24 (between end disk 26 and restraining piston 25) is in fluidic connection with the interior of the hydraulic cylinder between the two hydraulic pistons 5 and 6 or between hydraulic piston 6 and the closed end face of hydraulic cylinder 4.

As a result of the advantageously configured restraints 22, 23, it is achieved that the movement velocity of spring element 7, 8 during relief is damped or decelerated. As soon as restraining piston 25 has traversed lateral-wall openings 30 during the relaxation of spring element 7 or 8, a through-chamber or a damper chamber, from which the fluid is able to escape only slowly due to the leakage gap, is created between restraining piston 25 and end wall 27. In this way, the movement velocity of restraining piston 25 in restraining cylinder 24 is limited, and thus the expansion behavior of the respective spring element 7, 8 is slowed down. In this way, it is achieved that the respective spring element 7, 8 initially expands quickly, and then only slowly, to reach its starting position. This has the advantage that hydraulic pistons 5, 6 only experience a maximally permitted movement velocity due to the respective restrained spring during relief, i.e., when the driver takes his or her foot off brake pedal 3. In this way, impact noise of hydraulic pistons 5, 6 and pendulum movements on brake pedal 3 itself are prevented, which the driver may perceive as unusual and unpleasant.

Upon depression of brake pedal 3, the damping is effective until a hydraulic connection to the piston is reached. As a result of lateral-wall openings 30, restraint 22 or 23 is also easily displaceable within restraining cylinder 24 upon actuation of brake pedal 3, when hydraulic pistons 5 are being displaced in the actuating direction, as is shown by an arrow 31, until lateral-wall openings 30 have been traversed. Only then does further damping occur, which ensures that a hard impact of restraining piston 25 against end disk 26 or against end of restraining cylinder 24 assigned to end disk 26 is prevented. For this purpose, lateral-wall openings 30 are formed in restraining cylinder 24 spaced apart from end wall 26.

When decreasing the brake application or during relief, the accelerating forces of pedal sensation simulator 15 and the spring forces of spring elements 7, 8 act on hydraulic pistons 5, 6. The damped spring throttling effect decreases the acceleration of brake pedal 3. Starting at the point in time at which a so-called snifting bore in master brake cylinder 4 is opened due to the position of hydraulic pistons 5, 6, pedal sensation simulator 15 is no longer able to exert any further hydraulic pressure due to the fact that it is coupled purely hydraulically to master brake cylinder 4. As a result of damped spring restraint 22 or 23, moreover the accelerating moment of spring elements 7, 8 is limited, whereby brake pedal 3 is able to move into its resting position without further acceleration, without a noise and/or oscillations on the pedal being caused when the position is reached.

FIG. 3 shows an advantageous refinement of master brake cylinder 3, elements already known from FIG. 2 being denoted by the same reference numerals and reference being made to the above description in this regard. Hereafter, essentially the differences shall be addressed.

In contrast to the preceding exemplary embodiment, it is provided that end disks 29, 26 or restraints 22, 23 are each fixedly connected to hydraulic pistons 5, 6 or to the closed end wall of master brake cylinder 4. For this purpose, welding points 32 are shown in FIG. 3 by way of example.

When brake pedal 3 is actuated, the function is similar to that described above. However, when the brake application is decreased or during relief, it is additionally achieved that, due to hydraulic pistons 5, 6 fixedly connected to the respective restraint 22, 23, brake pedal 3 is or hydraulic pistons 5, 6 are not only accelerated less strongly, but moreover experiences or experience an active deceleration due to the damped restraints 22, 23, in addition to the damping. This is advantageous, in particular, with respect to the pedal sensation experienced by the driver, since in this way a brake pedal 3 returning too quickly is avoided, and the sensation of a conventional vacuum brake booster is achieved.

If the advantageous master brake cylinder 4 is used in a braking system 1 as described above, this has the advantage that a customary brake pedal behavior is ensured for the user, even though a vacuum brake booster is dispensed with, and instead, for example, an electromechanical or electrohydraulic brake booster 19 is used in braking system 1. Moreover, impact noise and/or stresses/damage caused by a hard impact is/are advantageously avoided due to a compact configuration.

1-10. (canceled)

11. A master brake cylinder for a braking system of a motor vehicle, comprising:
a hydraulic cylinder having multiple hydraulic connections and in which at least one hydraulic piston is mounted axially displaceably in an actuating direction and in a relief direction, the hydraulic piston being displaceable in an actuating direction against the force of a spring element; and
a restraint which limits the maximum spring relief assigned to the spring element, wherein the restraint includes a restraining cylinder and a restraining piston mounted axially displaceably in the restraining cylinder, the restraining cylinder having at least one lateral-wall opening so that an interior of the restraining cylinder is connected to an interior of the hydraulic cylinder.

12. The master brake cylinder of claim 11, wherein the lateral-wall opening opens into a section in the restraining cylinder into which the restraining piston is pushed during a displacement of the hydraulic piston in the actuating direction.

13. The master brake cylinder of claim 11, wherein the restraining piston is radially guided at least essentially closely against the restraining cylinder.

14. The master brake cylinder of claim 11, wherein the restraining cylinder and the restraining piston each include an end disk at their ends facing away from one another, the spring element being held between the end disks in an axially preloaded manner.

15. The master brake cylinder of claim 11, wherein the spring element is configured as a helical spring and situated coaxially to the restraining piston and the restraining cylinder.

16. The master brake cylinder of claim 11, wherein at least one of the end disks is fixedly connected to the hydraulic piston.

17. The master brake cylinder of claim 11, wherein the other of the end disks is connected to the hydraulic cylinder, in particular to a closed end wall of the hydraulic cylinder.

18. The master brake cylinder of claim 11, further comprising:
a tandem cylinder including a further hydraulic piston, which is axially displaceable in the hydraulic cylinder against the force of a further spring element and is situated between the hydraulic piston and the closed end face of the hydraulic cylinder.

19. The master brake cylinder of claim 11, wherein a further restraint, which is configured according to the one restraint, is assigned to the further hydraulic piston.

20. A braking system for a motor vehicle, comprising:
a master brake cylinder, which is connected to at least one hydraulic circuit including at least one hydraulically actuatable wheel brake;
wherein the master brake cylinder includes:
a hydraulic cylinder having multiple hydraulic connections and in which at least one hydraulic piston is mounted axially displaceably in an actuating direction and in a relief direction, the hydraulic piston being displaceable in an actuating direction against the force of a spring element; and
a restraint which limits the maximum spring relief assigned to the spring element, wherein the restraint includes a restraining cylinder and a restraining piston mounted axially displaceably in the restraining cylinder, the restraining cylinder having at least one lateral-wall opening so that an interior of the restraining cylinder is connected to an interior of the hydraulic cylinder.
